(19) United States
(12) Patent Application Publication
(10) Pub. No.: US 2025/0163546 A1
(43) Pub. Date: May 22, 2025

(54) HIGH TEMPERATURE ALUMINUM ALLOYS

(71) Applicant: Divergent Technologies, Inc., Los Angeles, CA (US)

(72) Inventors: Mu LI, San Pedro, CA (US); Christian Patino, Los Angeles, CA (US); Keith Mertan, Long Beach, CA (US); Chan Cheong Pun, Costa Mesa, CA (US); Michael Thomas Kenworthy, Rancho Palos Verdes, CA (US)

(21) Appl. No.: 18/814,143

(22) Filed: Aug. 23, 2024

Related U.S. Application Data
(60) Provisional application No. 63/657,757, filed on Jun. 7, 2024.
(60) Provisional application No. 63/584,282, filed on Sep. 21, 2023.
(60) Provisional application No. 63/578,639, filed on Aug. 24, 2023.

(51) Int. Cl. C22C 21/00; B33Y 70/00

(52) U.S. Cl. CPC C22C 21/00; B33Y 70/00

(57) ABSTRACT

An alloy may include iron (Fe), manganese (Mn) and aluminum (Al). The Fe may include the range 1% to 5.8% by weight of the alloy, the Mn may include the range 1.2% to 9.1% by weight of the alloy. The alloy may further include one or more of silicon (Si), nickel (Ni) and zirconium (Zr). Also, an alloy may include copper (Cu), magnesium (Mg), Zr and Al, wherein the Cu may include the range 0.8% to 5.1% by weight of the alloy, the Mg may include the range 0.5% to 3.9% by weight of the alloy and the Zr may include the range 0.3% to 10% by weight of the alloy, and the alloy may further include one or more of manganese, lithium, titanium, silicon, iron and nickel.

### CROSS REFERENCE TO RELATED APPLICATIONS

This application claims the benefit of U.S. Provisional Application No. 63/578,639 filed on Aug. 24, 2023, U.S. Provisional Application No. 63/584,282 filed on Sep. 21, 2023 and U.S. Provisional Application No. 63/657,757 filed on Jun. 7, 2024 all entitled “HIGH TEMPERATURE ALUMINUM ALLOYS FOR LASER POWDER BED FUSION”, wherein all three provisional applications are expressly incorporated by reference herein in their entirety.

### BACKGROUND

### Technical Field

The present disclosure relates generally to alloys, and more specifically to aluminum alloys.

### Description of the Related Technology

Additive Manufacturing (AM) processes involve the use of a stored geometrical model for accumulating layered materials on a build plate to produce three-dimensional (3-D) objects having features defined by the model. AM techniques are capable of printing complex components using a wide variety of materials, such as powder having the herein disclosed compositions and alloys. A 3-D object is fabricated based on a computer-aided design (CAD) model. The AM process can manufacture a solid three-dimensional object directly from the CAD model without additional tooling.

One example of an AM process is powder bed fusion (PBF), which uses a laser, electron beam, or other source of energy to sinter or melt metallic powder deposited in a powder bed, thereby consolidating powder particles together in targeted areas to produce a 3-D structure having the desired geometry. Different materials or combinations of materials, such as metals, plastics, and ceramics, may be used in PBF to create the 3-D object. Other and/or more advanced AM techniques, including those discussed further below, are also available or under current development, and each may be applicable to the present disclosure.

Another example of an AM process is called Binder Jet (BJ) process that uses a powder bed (similar to PBF) in which metallic powder is spread in layers and bonded by using an organic binder. The resulting part is a green part which requires burning off the binder and sintering to consolidate the layers into full density. The metallic powder material can have the same chemical composition and similar physical characteristics as PBF powders.

Another example of an AM process is called Directed Energy Deposition (DED). DED is an AM technology that uses a laser, electron beam, plasma, or other method of energy supply, such as those in Tungsten Inert Gas (TIG), or Metal Inert Gas (MIG) welding to melt the metallic powder or wire and rod, thereby transforming it into a solid metal object. Unlike many AM technologies, DED is not based on a powder bed. Instead, DED uses a feed nozzle to propel the powder or mechanical feed system to deliver wire and rod into the laser beam, electron beam, plasma beam, or other energy beam. The powdered metal or the wire and rod are then fused by the respective energy beam. While supports or a freeform substrate may in some cases be used to maintain the structure being built, almost all the raw material (powder, wire, or rod) in DED is transformed into solid metal, and consequently, little waste powder is left to recycle. Using a layer by layer strategy, the print head, comprised of the energy beam and the raw material feed system, can scan the substrate to deposit successive layers directly from a CAD model.

PBF, BJ, DED, and other AM processes may use various raw materials such as metallic powders, wires, or rods. The raw material may be made from various metallic materials. Metallic materials may include, for example, aluminum, or alloys of aluminum. It may be advantageous to use alloys of aluminum that have properties that improve functionality within AM processes. For example, particle shape, powder size, packing density, melting point, flowability, stiffness, porosity, surface texture, density electrostatic charge, as well as other physical and chemical properties may impact how well an aluminum alloy performs as a material for AM. Similarly, raw materials for AM processes can be in the form of wire and rod whose chemical composition and physical characteristics may impact the performance of the material. Some alloys may impact one or more of these or other traits that affect the performance of the alloy for AM.

Metal alloys, such as aluminum alloys, are often utilized in various engineering applications, such as automotive and aerospace. In many applications, these engineering applications may benefit from alloys that offer high performance and sustainability. Moreover, alloys that are economical may be more advantageous, e.g., as alloys that include rare and/or expensive elements may be impractical for relatively large-scale and/or commercial applications.

Existing alloys are mostly unsuitable for additive manufacturing (AM) applications, such as Selective Laser Melting (SLM) and/or Powder Bed Fusion (PBF). For example, not all alloys may be suitable for the rapid solidification through AM, which may include relatively small weld pools and/or may include very high cooling rates from liquid to solid states, such as cooling rates of approximately 10³° C./s to approximately 10⁶° C./s. For example, AM processes with alloys commonly used for traditional manufacturing (i.e., non-AM manufacturing) may result in microstructure and/or other characteristics of these alloys that are unacceptable—e.g., by resulting in defectives and/or unsafe products.

In view of the foregoing, there exists a need for high temperature and/or high performance alloys as well as economically feasible alloys for AM in various automotive, aerospace, and/or other engineering applications. The present disclosure describes alloys that may be implemented and used in AM processes, such as SLM, PBF, DED, and others. In this way, for example, additively manufactured structures of the alloys disclosed in this disclosure may be produced. The alloys of the present disclosure may provide improved properties for AM in automotive, aerospace, and/or other engineering applications. The alloys may yield improved performance in AM contexts, such as one or more of high strength (e.g., yield strength), ductility, fracture toughness, fatigue strength, corrosion resistance, elevated temperature strength, percent elongation, and/or any combination thereof. Furthermore, application of the alloys of the present disclosure may be economically feasible, for example, in a commercial context and/or production scale for AM in automotive, aerospace, and/or other engineering applications.

### SUMMARY

Several aspects of one or more alloys and compositions of alloys, as well as methods of making and/or using the same, are described herein. For example, one or more alloys or compositions thereof may be aluminum alloys. The one or more alloys may be used in three-dimensional (3-D) printing and/or additive manufacturing to produce additively manufactured structures. Illustratively, an alloy may include a composition containing a plurality of materials (e.g., elements, metals, etc.).

The disclosure further provides alloys and chemical compositions of alloys such as aluminum alloys, which were developed in house and may be readily additive manufactured. The alloys show good resistance to hot cracking, as well as ultra-high strength at room temperature in an as-printed state, while maintaining ductility (i.e., elongation before fracture/rupture) of more than six percent (i.e., 6%). The alloys may be heat treated to obtain even higher strength. The strengthening precipitates are thermally stable, which is ideal for high temperature applications of the disclosed alloys.

The addition of zirconium (Zr) within an alloy of aluminum (Al), copper (Cu) and magnesium (Mg) (i.e., Al—Cu—Mg—Zr) may help eliminate formation of cracks during an additive manufacturing process by providing nucleation sites for finer grain microstructures. At room temperature, the as-printed alloys may exhibit 450 MPa yield strength and 500 MPa yield strength. Also, at room temperature, the as-printed alloys may exhibit 486 MPa tensile strength/ultimate tensile strength and 500 MPa tensile strength/ultimate tensile strength. At temperatures up to 250 degrees Celsius (i.e., 250° C.), the alloys (e.g., DivMat-C3 AP, which corresponds to the compositions including Al—Cu—Mg—Zr—Mn) show superior strength over competitors. A ratio of copper to magnesium (i.e., Cu/Mg) may have values within the range from 3 to 1 (i.e., a ratio of Cu/Mg∈[1,3]) to generate a desired precipitate. Tensile strength and ultimate tensile strength are used interchangeably throughout this disclosure and have the same meaning, which is the maximum mechanical tensile (pulling) stress at the point where a specimen/sample fails/ruptures. Yield strength is at the point of plastic deformation of the specimen/sample. Percent elongation is the percentage that a material stretches beyond its original length before it breaks. Elongation is measured as the change in the length in a material sample divided by its original length and then multiplied by one hundred to convert elongation to a percentage.

According to some configurations of the present disclosure, an alloy may include iron (Fe), manganese (Mn) and aluminum (Al). The Fe in the alloy may include 1% by weight of the alloy and up to and including 5.8% (i.e., Fe∈[1%, 5.8%]) by weight of the alloy. The Mn in the alloy may include 1.2% (i.e., Mn∈[1.2%, 9.1%]) by weight of the alloy and up to and including 9.1% by weight of the alloy. The aluminum (Al) may include a balance of the weight percentage of the alloy, wherein the balance includes 100 percent by weight of the alloy minus the sum of the weight percentages of the other elements/components (i.e., all elements/components except Al) that comprise (i.e., make up) the alloy. For example, if an alloy includes elements/components X, Y and Z, where X has an amount of 5% by weight of the alloy and Y has an amount of 7% by weight of the alloy, then the balance (i.e., the weight percentage of Z in the alloy) may include 88% by weight of the alloy. In one configuration, the alloy may further include one or more of the elements silicon (Si), nickel (Ni), and zirconium (Zr). In one configuration, Si in the alloy may include up to and including 3.9% (i.e., Si≤3.9%) by weight of the alloy. In one configuration, Ni in the alloy may include up to and including 7.6% (i.e., Ni≤7.6%) by weight of the alloy. In one configuration, Zr in the alloy may include up to and including 3.8% (i.e., Zr≤3.8%) by weight of the alloy.

In some configurations of the present disclosure, an alloy may include copper (Cu), magnesium (Mg), zirconium (Zr) and aluminum (Al). The Cu in the alloy may include 0.8% by weight of the alloy and up to and including 5.1% (i.e., Cu∈[0.8%, 5.1%]) by weight of the alloy. The Mg in the alloy may include 0.5% by weight of the alloy and up to and including 3.9% (i.e., Mg∈[0.5%, 3.9%]) by weight of the alloy. The Zr in the alloy may include 0.3% by weight of the alloy and up to and including 10.0% (i.e., Zr∈[0.3%, 10%]) by weight of the alloy. The aluminum (Al) may include a balance of the weight percentage of the alloy. In one configuration, the alloy may include one or more of the elements manganese (Mn), lithium (Li), titanium (Ti), silicon (Si), iron (Fe) and nickel (Ni). In one configuration, Mn in the alloy may include up to and including 7.7% (i.e., Mn≤7.7%) by weight of the alloy. In one configuration, Li in the alloy may include up to and including 2.1% (i.e., Li≤2.1%) by weight of the alloy. In one configuration, Ti in the alloy may include up to and including 6.4% (i.e., Ti≤6.4%) by weight of the alloy. In one configuration, Si in the alloy may include up to and including 3.8% (i.e., Si≤3.8%) by weight of the alloy. In one configuration, Fe in the alloy may include up to and including 1.5% (i.e., Fe≤1.5%) by weight of the alloy. In one configuration, Ni in the alloy may include up to and including 1.5% (i.e., Ni≤1.5%) by weight of the alloy. In one configuration, the alloy may include a ratio of Cu to Mg (i.e., Cu/Mg) in the range from 1 to 3 (i.e., a ratio of Cu/Mg∈[1,3]), which includes the endpoint values of the range.

In an aspect of the disclosure, the alloys of the present disclosure may be configured with a balance of Al. In some aspects, the balance of the Al of an alloy may include up to 0.1% by weight of trace impurities cumulatively and 0.01% individually.

It will be understood that other aspects of alloys will become readily apparent to those skilled in the art from the following detailed description, wherein it is shown and described only several embodiments by way of illustration. As will be realized by those skilled in the art, the alloys, the alloy compositions and structures and the methods for manufacturing the alloys into structures are capable of other and different embodiments, and its several details are capable of modification in various other respects, all without departing from the invention. Accordingly, the drawings and detailed description are to be regarded as illustrative in nature and not as restrictive.

### BRIEF DESCRIPTION OF THE DRAWINGS

Various aspects of alloys that may be used for additive manufacturing, for example, in automotive, aerospace, and/or other engineering contexts are presented in the detailed description by way of example, and not by way of limitation, in the accompanying drawings, wherein:

FIGS. 1A-ID illustrate respective side views of a 3-D printer system in accordance with an aspect of the present disclosure.

FIG. 1E illustrates a functional block diagram of a 3-D printer system in accordance with an aspect of the present disclosure.

FIGS. 2A-2C illustrate alloy structures in accordance with an aspect of the present disclosure.

FIG. 3 illustrates a unit cell of a structure in accordance with an aspect of the present disclosure.

FIG. 4 illustrates yield strength versus temperature of different alloys.

FIG. 5 illustrates ultimate tensile strength versus temperature of different alloys.

FIG. 6 illustrates percent elongation versus temperature of different alloys.

### DETAILED DESCRIPTION

The detailed description set forth below in connection with the appended drawings is intended to provide a description of various exemplary embodiments of aluminum alloys are not intended to represent the only embodiments in which the invention may be practiced. The term “exemplary” used throughout this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the disclosure to those skilled in the art. However, the techniques and approaches of the present disclosure may be practiced without these specific details. In some instances, well-known structures and components may be shown in block diagram form, or omitted entirely, in order to avoid obscuring the various concepts presented throughout this disclosure.

One or more aspects of the present disclosure may be described in the context of the related technology. None of the aspects described herein are to be construed as an admission of prior art, unless explicitly stated herein.

In an aspect of the disclosure, alloys are described. For example, the disclosure describes high-performance and/or high temperature aluminum alloys. The alloys may be used in a 3-D printer and/or AM processes. For example, the disclosed alloy may comprise the material sintered or melted by a laser beam within a powder bed fusion (PBF) 3-D printer.

In an aspect of the disclosure, the disclosed alloys may obtain various properties through one or combination of the following processes: solid solution strengthening, strain hardening, precipitation strengthening, and/or dispersion strengthening. The processes of solid solution strengthening, strain hardening, precipitation strengthening, grain or phase boundary strengthening, and/or dispersion strengthening may take place during solidification, subsequent thermal processing, intermediate cold working, or some combination of these.

Solidification processes and subsequent cooling in solid state in AM may differ from those processes occurring through conventional techniques. For example, the solidification in PBF processing occurs on a microscale, layer by layer, with each layer undergoing one or more melting, solidification, and cooling cycles. In such a process, melting may begin at approximately 610° C. and may conclude at approximately 696° C. Due to the small size of the melt pool, the cooling rate is extremely high relative to conventional techniques e.g., the cooling rate may be from approximately 10³° C./second to approximately 10⁶° C./second. Therefore, non-equilibrium thermodynamics and phase transformation kinetics may become the dominate drivers during AM, thereby making alloys exhibit different properties with AM, such as through inheriting element supersaturation and alloy partitioning.

Thus, in an aspect of this disclosure, the present disclosure describes alloys that may be used in AM (e.g., PBF process) and may provide high performance with AM. The performance of these alloys of the present disclosure may be improved in an as-printed state, e.g., after undergoing thermal processing (post AM), or some combination of both in the as-printed state and after undergoing thermal processing.

In one example configuration, one or more alloys of the present disclosure may be tailored for superior strengthening where the one or more alloys would have high ultimate tensile strength at room temperature and at an elevated temperature. In another exemplary configuration, one or more of the alloys of the present disclosure may be designed for superior ductility where the one or more alloys would have high elongation at room temperature and at an elevated temperature.

One or more alloys of the present disclosure may be specifically designed in order to accommodate high temperatures, rapid melting, solidification, and/or cooling experienced by alloys in AM (e.g., PBF process). For example, the alloying elements and concentrations (i.e., an elements weight percentage of the alloy) thereof may be configured such that intermetallics may be formed with other alloying elements during rapid cooling. Further, the alloying elements and concentrations thereof may be configured based on the liquid and/or solid solubilities of the alloying elements in the aluminum matrix. The alloying elements and concentrations thereof may be configured such that the alloying elements may form supersaturated solid solutions and/or nano-precipitates after rapid solidification and cooling during AM (e.g., PBF process). The alloying elements and the concentrations thereof may be configured to form intermetallics and the phases thereof during subsequent thermal processing, for example, including precipitation heat treatment and/or Hot Isostatic Pressing (HIP). Finally, the alloying elements and concentrations thereof may be configured to form targeted specific intermetallics during rapid solidification and cooling such that the phases formed thereby may enhance the performance of the one or more alloys of the present disclosure. Additionally, the configurations of the alloying elements and the concentrations thereof may result in the formation of phases during subsequent thermal processing that improves the mechanical performance of the one or more alloys of the present disclosure.

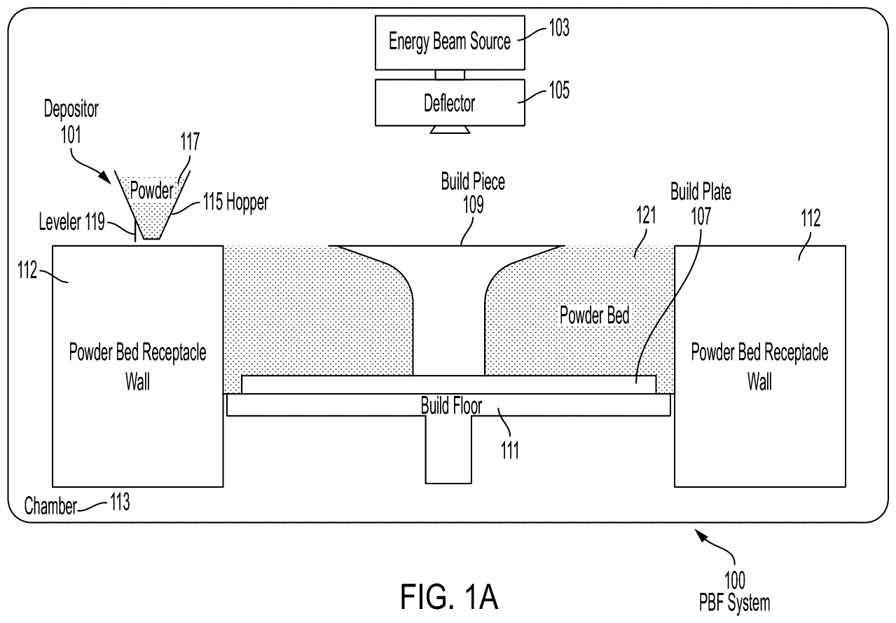

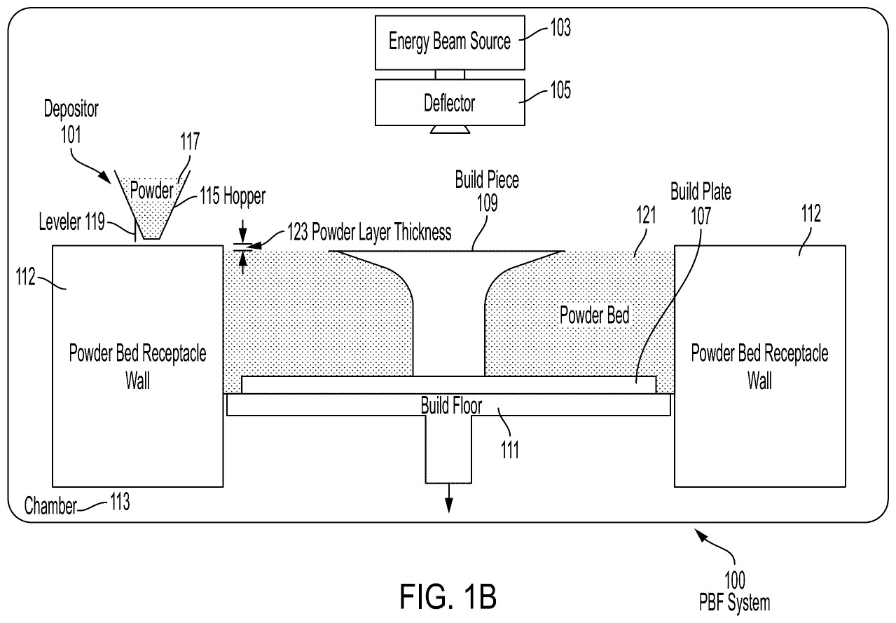

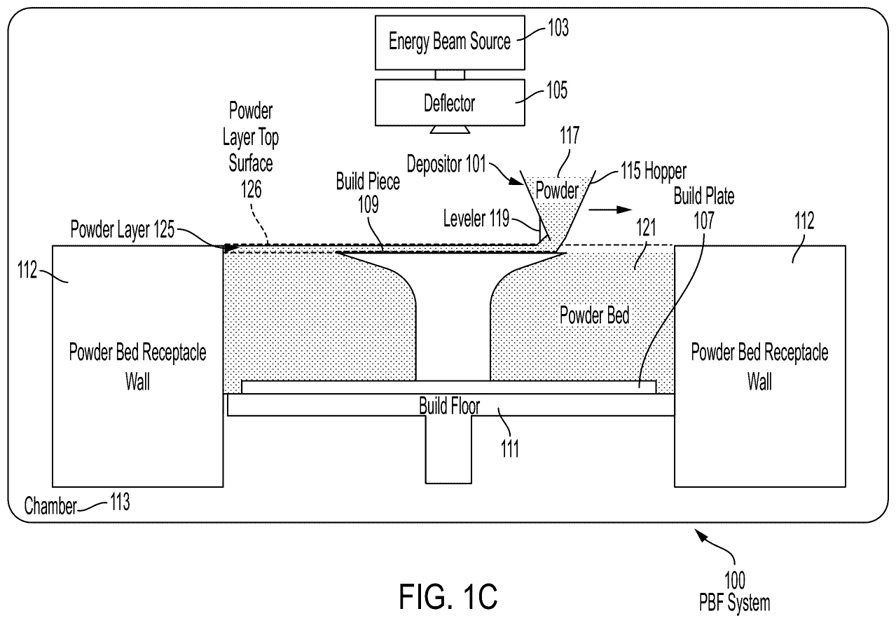

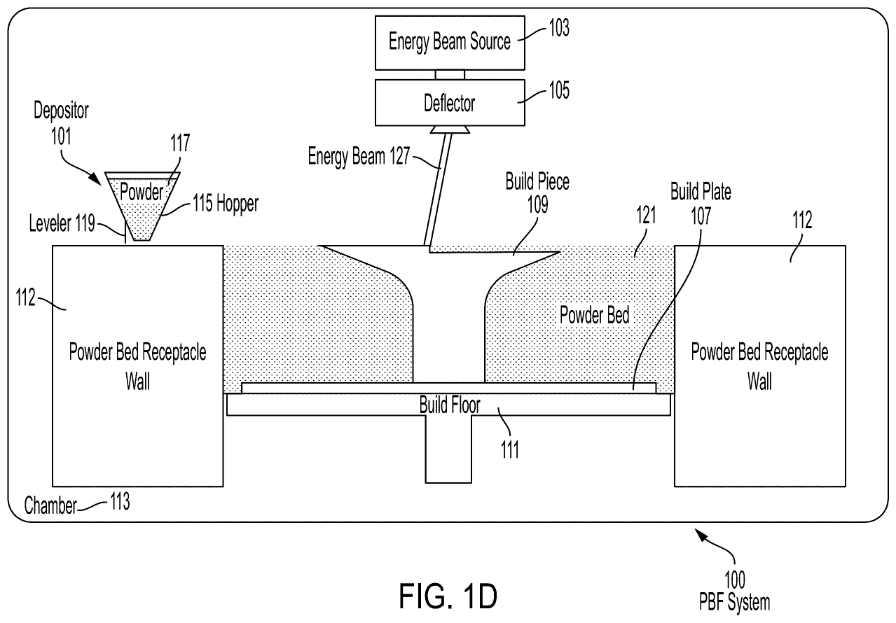

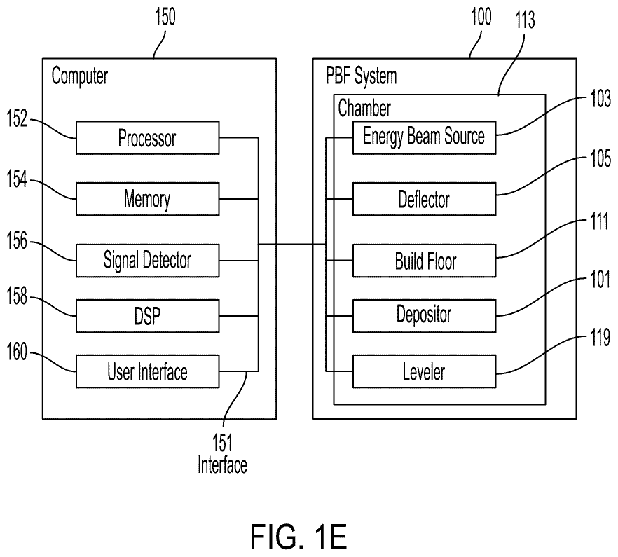

FIGS. 1A-D illustrate respective side views of an exemplary 3-D printer system.

In this example, the 3-D printer system is a powder-bed fusion (PBF) system 100. FIGS. 1A-D show PBF system 100 during different stages of operation. The particular embodiment illustrated in FIGS. 1A-D is one of many suitable examples of a PBF system employing principles of this disclosure. It should also be noted that elements of FIGS. 1A-D and the other figures in this disclosure are not necessarily drawn to scale, but may be drawn larger or smaller for the purpose of better illustration of concepts described herein.

PBF system 100 may be an electron-beam PBF system 100, a laser PBF system 100, or other type of PBF system 100. Further, other types of 3-D printing, such as Directed Energy Deposition. Selective Laser Melting. Binder Jet, etc., may be employed without departing from the scope of the present disclosure.

PBF system 100 may include a depositor 101 that can deposit each layer of powder 117, an energy beam source 103 that can generate an energy beam 127, a deflector 105 that can apply the energy beam to fuse the powder material, and a build plate 107 that can support one or more build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of the present disclosure.

PBF system 100 may also include a build floor Ill positioned within a powder bed receptacle. Powder bed receptacle walls 112 of the powder bed receptacle generally define the boundaries of the powder bed receptacle, which is sandwiched between the powder bed receptacle walls from the side and abuts a portion of the build floor below. The build floor can progressively lower the build plate so the depositor can deposit a next layer. The entire mechanism may reside in a chamber 113 that can enclose the other components, thereby protecting the equipment, enabling atmospheric and temperature regulation and mitigating contamination risks. The depositor may include a hopper 115 that contains the powder, such as a metal powder, and a leveler 119 that can level the top of each layer of deposited powder.

AM processes may use various metallic powders, such as one or more alloys of the present disclosure. The particular embodiments illustrated in FIGS. 1A-D are some suitable examples of a PBF system employing principles of the present disclosure. Specifically, one or more of the alloys, which may be aluminum alloys, described herein may be used in at least one PBF system 100 described in FIGS. 1A-D. While one or more alloys described in the present disclosure may be suitable for various AM processes (e.g., using a PBF system, as shown in FIGS. 1A-D), it will be appreciated that one or more alloys of the present disclosure may be suitable for other applications, as well. For example, one or more alloys described herein may be used in other fields or areas of manufacture without departing from the scope of the present disclosure. Accordingly, AM processes employing the one or more alloys of the present disclosure are to be regarded as illustrative, and are not intended to limit the scope of the present disclosure.

Prior to use in PBF system 100, the elements of an alloy, which may be an aluminum alloy, may be combined into a composition according to one of the examples/configurations described herein. For example, the elements in respective concentrations described in one of the examples/configurations of the present disclosure may be combined when the elements are molten. The composition may be mixed while the elements are molten, e.g., in order to promote even distribution of each element with the balance of a base material, which may be aluminum. The molten composition may be cooled and atomized. Atomization of the composition may yield a metallic powder that includes the elements of the examples/configurations of the present disclosure, and can be used in additive manufacturing systems such as PBF system 100. Referring specifically to FIG. 1A, this figure shows the PBF system after a slice of the build piece has been fused, but before the next layer of powder has been deposited. In fact, FIG. 1A illustrates a time at which the PBF system has already deposited and fused slices in multiple layers, e.g., 150 layers, to form the current state of the build piece, e.g., formed of 150 slices. The multiple layers already deposited have created a powder bed 121, which includes powder that was deposited but not fused.

FIG. 1B shows PBF system 100 at a stage in which build floor 111 can lower by a powder layer thickness 123. The lowering of the build floor causes build piece 109 and powder bed 121 to drop by the powder layer thickness, so that the top of the build piece and the powder bed are lower than the top of powder bed receptacle walls 112 by an amount equal to the powder layer thickness. In this way, for example, a space with a consistent thickness equal to the powder layer thickness can be created over the tops of the build piece and the powder bed.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, the depositor progressively moves over the defined space while releasing the powder from hopper 115. Leveler 119 can level the released powder to form a powder layer 126 that has a thickness substantially equal to the powder layer thickness 123 (see FIG. 1B). Thus, the powder in a PBF system may be supported by a powder material support structure, which may include, for example, a build plate 107, a build floor 111, a build piece 109, powder bed receptacle walls 112, and the like. It should be noted that the illustrated thickness of powder layer 125 (i.e., powder layer thickness 123 (FIG. 1B)) is greater than an actual thickness used for the example involving 150 previously-deposited layers discussed herein with reference to FIG. 1A.

FIG. 1D shows PBF system 100 at a stage in which, following the deposition of powder layer 125 (FIG. 1C), energy beam source 103 generates an energy beam 127 and deflector 105 applies the energy beam to fuse the next slice in build piece 109.

In various example embodiments, the energy beam source may be an electron beam source, in which case the energy beam constitutes an electron beam. The deflector may include deflection plates that can generate an electric field or a magnetic field that selectively deflects the electron beam to cause the electron beam to scan across areas designated to be fused. In various embodiments, the energy beam source may be a laser, in which case the energy beam is a laser beam. The deflector may include an optical system that uses reflection and/or refraction to manipulate the laser beam to scan selected areas to be fused.

In various embodiments, the deflector may include one or more gimbals and actuators that can rotate and/or translate the energy beam source to position the energy beam.

In various embodiments, the energy beam source and/or the deflector can modulate the energy beam, e.g., turn the energy beam on and off as the deflector scans so that the energy beam is applied only in the appropriate areas of the powder layer. For example, in various embodiments, the energy beam can be modulated by a digital signal processor (DSP).

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within the PBF system. Such a device may be a computer 150, which may include one or more components that may assist in the control of the PBF system. The computer may communicate with the PBF system, and/or other AM systems, via one or more interfaces 151. The computer and/or the interface are examples of devices that may be configured to implement the various methods described herein, that may assist in controlling the PBF system and/or other AM systems.

In an aspect of the present disclosure, the computer may comprise at least one processor 152, memory 154, signal detector 156, digital signal processor (DSP) 158, and one or more user interfaces 160. The computer may include additional components without departing from the scope of the present disclosure.

The processor may assist in the control and/or operation of the PBF system. The processor may also be referred to as a central processing unit (CPU). The memory, which may include both read-only memory (ROM) and random access memory (RAM), may provide instructions and/or data to the processor. A portion of the memory may also include non-volatile random access memory (NVRAM). The processor typically performs logical and arithmetic operations based on program instructions stored within the memory. The instructions in the memory may be executable (by the processor 152, for example) to implement the methods described herein.

The processor may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format. RS-274 instructions (G-code), numerical control (NC) programming language, and/or any other suitable format of code). The instructions, when executed by the one or more processors, cause the processing system to perform the various functions described herein.

The signal detector may be used to detect and quantify any level of signals received by the computer for use by the processor and/or other components of the computer. The signal detector may detect such signals as energy beam source power, deflector position, build floor height, amount of powder remaining in the depositor, leveler position, and other signals. The DSP may be used in processing signals received by the computer. The DSP may be configured to generate instructions and/or packets of instructions for transmission to the PBF system.

The user interface may comprise a keypad, a pointing device, and/or a display. The user interface may include any element or component that conveys information to a user of the computer and/or receives input from the user.

The various components of the computer may be coupled together by the interface, which may include, e.g., a bus system. The interface may include a data bus, for example, as well as a power bus, a control signal bus, and a status signal bus in addition to the data bus. Components of the computer may be coupled together or accept or provide inputs to each other using some other mechanism.

Although a number of separate components are illustrated in FIG. 1E, one or more of the components may be combined or commonly implemented. For example, the processor may be used to implement not only the functionality described herein with respect to the processor, but also to implement the functionality described herein with respect to the signal detector, the DSP, and/or the user interface. Further, each of the components illustrated in FIG. 1E may be implemented using a plurality of separate elements.

### Alloy Structures

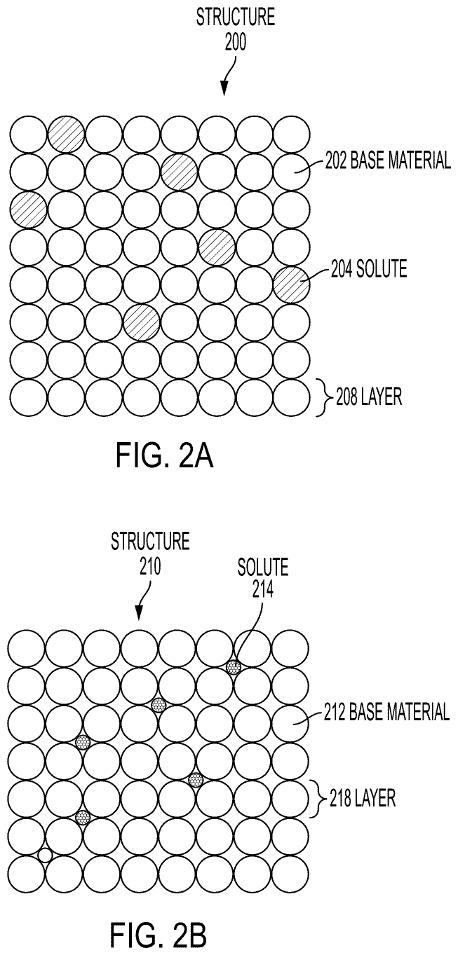

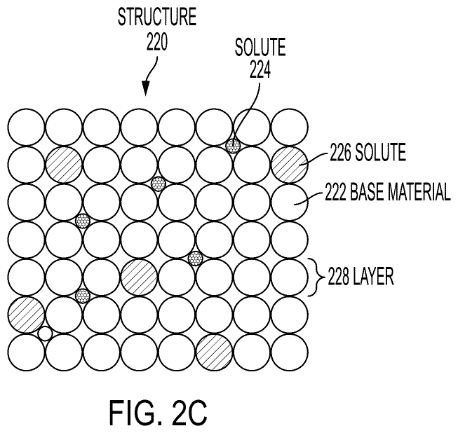

FIGS. 2A and 2B illustrate alloy structures in accordance with an aspect of the present disclosure.

FIG. 2A illustrates an alloy structure 200 with base material atoms and solute atoms included in the alloy structure. In an aspect of the present disclosure, the alloy structure may have an underlying structure of a base material 202, which may be, for example, a crystalline-type or periodic structure, such as a cubic structure, i.e., where an atom of the base material is located at each corner of a cube, a face-centered cubic (fcc) structure, i.e., where an atom of the base material is located at the corners and in at least one face of a cube, etc. For example, as a base material, aluminum (Al) metal arranges in a face-centered cubic (fcc) structure, titanium arranges in a body-centered cubic (bcc) structure or a hexagonal close packed (hcp) structure, etc. As shown in FIG. 2A, atoms of the base material can be arranged in layers, such as a base material layer 208, which may include one or more atoms of substitutional solute 204.

In FIG. 2A, the base material structure of the alloy structure is shown as a cubic structure, however, the principles described with respect to the alloy structure may be applied to any base material structural arrangement without departing from the scope of the present disclosure. In FIG. 2A, at some locations within the alloy structure, the base material has been replaced by the solute. With a replacement approach, an alloy may be referred to as a “substitutional alloy,” because the solute is substituting for the base material within the base material structure of the alloy structure. In an aspect of the present disclosure, the solute may be one or more different atoms and/or compounds that act as substitutional replacements for the base material. Substitutional alloys may be formed when the solute is of approximately the same atomic size as the base material.

In FIG. 2B, an alloy structure 210 includes a base material 212 within a cubic structure like/similar to the base material structure shown in FIG. 2A. Like FIG. 2A, the principles described with respect to the alloy structure may be applied to any base material structural arrangement without departing from the scope of the present disclosure. The alloy structure may also include a solute 214. The solute is included in the alloy structure at locations other than the locations of the base material, i.e., at interstitial locations within the base material structure of the alloy structure. In such an aspect of the present disclosure, an alloy with such an addition to the base material may be referred to as a “interstitial alloy,” because the solute is being made part of the structure at interstitial locations within the base material structure of the alloy structure. In such an aspect, the solute may be one or more different atoms and/or compounds that act as interstitial insertions into the base material structure of the alloy structure. Interstitial alloys may be formed when the solute is of a smaller atomic size than the base material. As shown in FIG. 2B, atoms of the base material can be arranged in layers, such as a base material layer 218, which may include one or more atoms of the interstitial solute 214 interspersed between the layers.

FIG. 2C illustrates an example of a combination alloy, with an alloy structure 220 that may include a base material 222, an interstitial solute 224, and a substitutional solute 226. As shown in FIG. 2C, atoms of the base material can be arranged in layers, such as a base material layer 228, which may include one or more atoms of the substitutional solute and interspersed with one or more atoms of the interstitial solute.

Aspects of the present disclosure can include substitutional alloys, interstitial alloys, and combination alloys with combinations of the substitutional/interstitial solutes in a given alloy. Further, a base material (such as base material 202, 212, and 222) may include one or more elements, e.g., the base material may be a material, e.g., copper (Cu), without departing from the scope of the present disclosure. Although the use of “base” in base material may mean that the base material is the majority of the composition of the alloy, such meaning is not necessarily the case in many aspects of the present disclosure. In various embodiments, base material may indicate an underlying structure of the alloy, since different materials have different atomic arrangements. e.g., fcc, bcc, cubic, hcp, etc.

In an aspect of the present disclosure, solutes can be included with a base material to change one or more properties that the base material exhibits. For example, and not by way of limitation, carbon (C) may be added to Fe to increase strength and reduce oxidation. In other words, solutes may be added as impurities to a base material to change the characteristics of the bonds between atoms within a base material structure.

In many materials, and in many alloys, there are several basic characteristics that determine the suitability of that material/alloy for a given application. For example, and not by way of limitation, strength, heat resistance, and ductility are three characteristics that may be of interest in certain applications.

As shown in FIGS. 2A-C, a structure of an alloy, which may include base material(s) and solutes, can be classified in terms of its underlying atomic arrangements (e.g., fcc, bcc, hcp, etc.). Alloy structures can be made in a number of ways, but they are primarily fashioned by mixing together a base material with solutes (e.g., substitutional and/or interstitial) in various ratios and/or percentages. This may be done through smelting and/or melting the various components into a homogenous liquid and allowing the liquid to cool into a solid form.

The resultant alloy structure, whether interstitial, substitutional, polycrystalline, amorphous, or various combinations, provides different values for the properties of the alloy than the properties of the base material in a pure form. For example, alloying gold (Au) with silver (Ag) makes the resultant alloy harder, i.e., the resultant alloy of Au and Ag has a higher tensile strength than pure Au. Another reason that a pure base material structure may show reduced strength is that covalent and/or ionic bonding between atoms of the same element is limited. Since alloys contain a mixture of atom sizes, and a variety of valence electrons because some of the atoms in the alloy's structure can have slightly different sizes and/or different localized electrical properties, it is more difficult for layers in the base material arrangement, such as the base material layers, to shift with respect to one another, as the arrangement of atoms is no longer uniform and the localized bond strength between neighboring atoms may be increased. This increase in strength of the alloy may be due to the slight difference in the size of a substitutional solute, the inclusion of an interstitial solute, and/or other reasons.

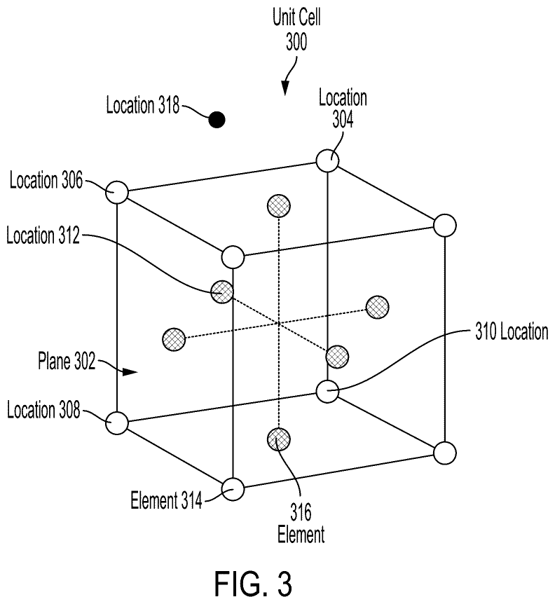

FIG. 3 illustrates a unit cell of a structure in accordance with an aspect of the present disclosure.

Unit cell 300 shows a single cube of an alloy structure, which, as illustrated in FIG. 3, is a face centered cubic (fcc) structure. For ease of understanding, plane 302 is shown, although the unit cell has six planes that are approximately perpendicular to each other at each intersection. Other unit cells are possible, e.g., bcc, cubic, hcp, etc., without departing from the scope of the present disclosure.

The plane is described by five atomic locations: location 304, location 306, location 308, and location 310, which define the “corners” of the plane, and location 312, which defines the “center” of the plane within the face of the unit cell closest to the viewer. In an alloy structure, one unit cell 300 may be adjacent to another unit cell 300, etc., such that a large array of unit cells 300 defines the alloy structure.

An element 314 is located in this example at each of the corners of the unit cell, including at locations 304, 306, 308, and 310 of the plane. An element 316 is located at the center of each one of the six planes, including at location 312. That is, as shown in FIG. 3, locations 304-310 are occupied by element 314, and location 312 is occupied by element 316. Element 314 may be the same material/element as element 316, or may be a different material/element depending on the composition of the resultant alloy. In an alloy structure with unit cells of a pure material, e.g., aluminum, each location 304-310 and location 312 would be occupied by aluminum.

If a substitutional solute were introduced as an alloying material for pure aluminum, then one or more locations 304-312 may be occupied by the alloying material. If an interstitial solute were added as an alloying material for pure aluminum, such a solute may be located, for example, location 318. Location 318 is between location 306 and location 304, and in an aspect of the present disclosure, within plane 302. Other locations for an interstitial solute are possible without departing from the scope of the present disclosure.

Aluminum, which has an fcc unit cell as shown in FIG. 3, has been alloyed with various solutes. Some aluminum alloys have been standardized and named based on which solute(s) are included in the named alloy. For example, and not by way of limitation, the International Alloy Designation System (IADS) is a widely-accepted naming scheme for aluminum alloys, where each alloy is referred to using a four-digit number. The first digit of the number indicates the major solute elements included in the alloy. The second digit indicates any variants for that solute alloy, and the third and fourth digits identify a specific alloy in that series.

For aluminum alloys named (i.e., numbered) in the IADS, 1000 series alloys are essentially pure aluminum content by wt %, and the other digits represent various applications for such alloys. 2000 series aluminum alloys are alloyed with Cu, 3000 series aluminum alloys are alloyed with Mn, 4000 series aluminum alloys are alloyed with silicon (Si), 5000 series aluminum alloys are alloyed with Mg, 6000 series aluminum alloys are alloyed with Mg and Si, 7000 series aluminum alloys are alloyed with Zn, and 8000 series aluminum alloys are alloyed with other elements or a combination of elements that are not covered by other series designations. As an example, and not by way of limitation, a common aluminum alloy is referred to as “6061” which, per the IADS naming scheme, has Mg and Si as the major alloying solutes.

However, when the manufacturing process of creating such alloys is changed from smelting, forging, and/or casting to 3-D printing, the formation of the alloy structure and/or the unit cells within the alloy structure becomes localized. Since 3-D printing only applies thermal energy to a small portion of the overall alloy structure at any given time, the formation of the unit cells happens on a local scale in the build piece instead of on a global scale, for example, in a cast piece. As a result of the local versus global thermal energy application, and local versus global cooling of the build piece, it has been seen that some named, common alloys of aluminum are difficult to 3-D print without introducing micro-fractures and/or other deleterious structural defects in the build piece.

### Strengthening Mechanisms in Metals

As seen with respect to the descriptions accompanying FIGS. 2A-C, there can be a plurality of ways to increase strength of a base material. The “strength” of a given material can also be described in a plurality of ways. The amount of force required to break a material is often referred to as the “tensile strength” or “ultimate tensile strength” of the material, while the amount of force required to permanently bend or deform a material may be referred to as the “yield strength” of the material. Several mechanisms may be responsible for increasing the tensile strength and/or yield strength of a given material. Such mechanisms in alloys may include, for example, changing the “smoothness” between base material layers in the alloy structure, either by introducing a substitutional solute, an interstitial solute, or a combination of substitutional and interstitial solutes. The introduction of solutes can create areas within an alloy structure that are not uniform, and may be referred to as “dislocations” within the alloy.

Dislocations may introduce different attraction and/or repulsion forces, known as stress fields, within an alloy structure. This creates a localized differential between forces within the alloy structure, known as a “pinning point”, that opposes motion of one or more base material layers of the structure proximate that pinning point.

Increasing the number of dislocations per unit of volume of the alloy structure will normally increase the tensile strength and/or yield strength of an alloy versus its base material structure in pure form. However, above a certain point, which may be different for each base material, an increased density of dislocations will begin to lower the tensile strength and/or yield strength of the alloy. If the localized differential of attractive and/or repulsive forces becomes widespread enough, it can reduce and/or eliminate any contribution of attraction and/or repulsive forces of the base material from the overall strength determination for the alloy, or it can cause the alloy structure to change form to a different underlying arrangement of the atoms in the alloy structure (e.g., from fcc to bcc, etc.).

As such, increasing the dislocation density, to a point, increases the shearing force needed to move one base material layer with respect to another. This is so because additional shearing force would be required to move the dislocations that lie within the layer(s) as well as the force needed to move the base material in those base material layers. This increase in shearing force needed to move the dislocations is exhibited as an increase in tensile strength and/or yield strength in the alloy.

However, increasing the strength of a base material may decrease other properties that the base material exhibits when the base material is in a pure form. For example, and not by way of limitation, increasing the strength may decrease the malleability of that base material. It may be known that stronger materials are harder to bend or dent. The malleability and/or elongation abilities of a material is often referred to as the “ductility” of the material. Changing how strong a material is, i.e., the ability of the material to resist force, often also changes how “workable” the material is, i.e., the ability to absorb force through deformation of the material rather than breakage of the material. Although many of the discussions herein refer to strengthening a material, in an aspect of the present disclosure, the strength of a given alloy can be improved without causing a significant effect on the ductility of the alloy.

### Work Hardening

A typical structure of a pure base material may be a regular, nearly defect-free lattice. To harden a material through “work hardening,” dislocations are introduced into the base material through forming or otherwise “working” the material. These dislocations may create localized fluctuations of the stress fields in the material, which slightly rearranges the structure of the base material.

Work hardening of a base material may be achieved by applying mechanical and/or thermal stresses to the base material. For example, a sheet of Cu may be hammered, stretched, or run through pressurized rollers to reduce the material thickness. These mechanical stresses introduce dislocations into the Cu structure (which is a face centered cubic). This forming of Cu increases the hardness (strength) and decreases the elasticity (commonly referred to as the “ductility”). Similar hardening can be achieved through thermal cycling, e.g., heating and cooling of the material, such as is done with furnaces and quenching of iron to temper the material.

As described herein, if “working” a base material continues beyond a certain point, the base material will contain too large a concentration of dislocations which may result in fractures, such as micro-fractures and/or visible fractures. Such fractures may be reversible, e.g., through one or more heating and cooling cycles of the material during and/or after working of the base material. Heating and cooling of the material in such a manner may be referred to as “annealing” the base material.

Work hardening may be performed on a base material without introducing a substitutional and/or interstitial solute to form an alloy. Work hardening may also be performed on alloys that include solutes with a base material.

### Solid Solution Strengthening

In an aspect of the present disclosure, a substitutional and/or interstitial solute may be added to a base material, which can result in substitutional and/or interstitial point defects in the alloy structure. The solute atoms can cause lattice distortions in the alloy structure that impede dislocation motion. When dislocation motion is impeded, the strength of the material is increased. This particular mechanism of strengthening a base material may be referred to as “solid solution strengthening.”

In solid solution strengthening, the presence of solute atoms can introduce compressive or tensile stresses to the alloy structure lattice, which may interact with nearby dislocations, causing the solute atoms to act as potential barriers to the movement of layers of the structure with respect to each other. These interactions may increase the tensile strength and/or yield strength of a given alloy.

Solid solution strengthening generally depends on the concentration of the solute atoms present in the alloy structure. Some physical properties of substitutional and/or interstitial solute atoms that may be considered when determining which particular element to include in a given alloy may be the shear modulus of the solute atoms, the physical size of solute atoms, the number of valence electrons (also known as the “valency”) of solute atoms, and the symmetry of the solute stress field, as well as other properties.

### Precipitation Hardening

As a molten metal alloy cools, the base material atoms may form molecules and/or bond directly with solute(s) (or other impurities) instead of forming bonds with other base material atoms. The molecules/bonds formed between the base material and solute(s) or impurities will likely create different localized properties than in the pure base material structure and/or pure solute(s) structure. One of these properties may be the melting point of the molecule, which may be different from that of the pure base material and/or pure solute(s).

In an aspect of the present disclosure, the molecules may harden at a higher temperature than the pure base material and/or pure solute(s), which may create dislocations in the alloy structure. These dislocations may create substructures within the alloy structure that may be referred to as a different “phase” of the alloy structure. Because molecules of different sizes within the alloy structure may make it more difficult for base material layers to move with respect to each other within the alloy structure, these molecules may assist in creation of a stronger alloy.

This change in properties of the molecules, which may be referred to as a change in “solid solubility” with respect to temperature, when it affects the strength of the resultant alloy, may be referred to as a “precipitation hardening” mechanism. Because the melting points of the elements included in the alloy may be different, precipitation hardening (also known as “precipitation strengthening”) may be dependent upon temperature.

Precipitation hardening uses these changes in solid solubility with respect to temperature to produce fine particles, e.g., molecules as described herein, of an impurity phase, or “second phase,” which impede the movement of dislocations. These particles that compose the second phase precipitates act as pinning points in a similar manner.

The particles may be of a similar size, or coherent size, as the base material. If the sizes of the particles and the base material are similar enough, the alloy structure can remain relatively coherent, e.g., can remain in a bcc or cubic form. However, in localized areas of the alloy structure, bowing and/or depressions may exist in the base material layers. This mechanism may be referred to as “coherency hardening” of the alloy structure, which is similar to solid solution hardening.

Where the particles have a different response to shear stress than the base material, this difference may change the tension and or internal stresses within the alloy structure. This response to shear stress is known as the “shear modulus” and because the particles can withstand a different amount of stress, the overall amount of stress that the alloy structure can withstand can be increased. This mechanism of precipitation hardening may be referred to as “modulus hardening” of the alloy structure.

Other types of precipitation hardening may be chemical strengthening and/or order strengthening, which are changes in the surface energy and/or an ordered structure of the particles within the alloy structure, respectively. Any one or more of these mechanisms may be present as a part of precipitation hardening in an alloy in an aspect of the present disclosure.

### Dispersion Strengthening

Similar to precipitation hardening, changes in properties of the molecules, scattering different particles, molecules, and/or solutes within an alloy structure that are of different sizes than the base material may create dislocations within the alloy structure. Although these particles may be larger than those used for precipitation hardening, the mechanism of reducing the ability of the base material layers from moving with respect to each other is similar. This mechanism may be referred to as “dispersion strengthening” to differentiate it from precipitation hardening. One type of dispersion strengthening is the introduction of an oxide of a base material in the alloy structure.

### Grain Boundary Strengthening

In an aspect of the present disclosure, a unit cell of the alloy structure, e.g., one cube of an fcc, bcc, or cubic structure, etc., may be referred to as a “grain” or “crystallite” within the alloy structure. Solutes may affect the alloy structure by changing the average grain size within the alloy structure. When grains within the alloy structure have different sizes, the interface between adjacent grains, known as the “grain boundary,” acts as a dislocation within the alloy structure. Grain boundaries act as borders for dislocation movement, and any dislocation within a grain affects how stresses build up or are relaxed in adjacent grains.

Such a mechanism may be referred to as “grain boundary strengthening” of a base material in an alloy. In an aspect of the present disclosure, grains within the alloy structure may have different crystallographic orientations, e.g., bcc, fcc, cubic, etc. These differing orientations and sizes create grain boundaries within the alloy structure. When the alloy structure is subjected to external stress, slip motion between base material layers may take place. However, the grain boundaries act as an impediment to slip motion between base material layers because the base material layers do not have uniform, even surfaces where slip motion can occur.

### Transformation Strengthening

As described herein with respect to precipitation hardening, a base material may cool into different “phases” depending on the rate of cooling, the temperature of cooling, and/or other factors. For example, titanium (Ti) may form two different types of grains, known as α-titanium and β-titanium. α-titanium is formed when the molten titanium metal crystallizes at low temperatures, and forms a hcp lattice structure. β-titanium forms when the molten titanium crystallizes at higher temperatures, and forms a bec lattice structure. These different structures within an overall alloy structure create a stronger alloy, because the base material layers' smooth interfaces with each other are interrupted by the change in grain size and lattice structure of the different phases of the base material and/or solute(s). This mechanism for strengthening alloys is known as “transformation strengthening.”

In an aspect of the present disclosure, transformed phases of various base materials and/or solutes may occur as a function of heating and/or cooling the resultant alloy during formation of the alloy, e.g., heating the alloy to a certain temperature, cooling the alloy at a certain rate, heat treatment, etc. In an aspect of the present disclosure, during the 3D printing process of a given alloy, the temperature of the energy beam source (e.g., the amount of energy being delivered by the energy beam source), the speed that the energy beam travels across the powder bed (e.g., the speed of the deflector), and/or other factors may be selected to supply a desired temperature profile to the powder bed. For example, and not by way of limitation, the heating and/or cooling of a given powder may be selected to approximate a heating and/or cooling profile to create desired phases of the base materials and/or solutes in the resultant alloy, and a different heating and/or cooling of a different powder may be selected to create a different temperature profile to create desired phases in the powders resultant alloy. In an aspect of the present disclosure, the temperature profile(s) delivered by the PBF system may also take into account any post-printing heat treatments, such that the combined printing/heat treatments may be performed in a more efficient manner.

In iron (Fe) structures, high levels of carbon (C) and manganese (Mn) solutes create two different grains within the alloy structure, ferrite, which is a bcc lattice structure, and martensite, which is a body-centered tetragonal (bet) lattice structure. These differing lattices within a Fe-based alloy structure strengthen the Fe into steel, because adjacent ferrite and martensite lattice structures disrupt the planar continuity of the base material layer interfaces, and the solutes (C and Mn) act as interstitial solutes to further disrupt the base material layer planes. Depending on how the alloy is heat treated, other lattice structures of Fe, e.g., austenite (which has an fcc lattice structure), bainite (which has a slightly different sized bet lattice structure than martensite), cementite (orthorhombic Fe₃C), and/or other compounds, may also be formed.

A form of transformation strengthening, such as the creation of cementite in a Fe-based alloy structure, may also be referred to as “triferrite particle formation” within the alloy structure. Of course, if the base material is titanium, such transformation strengthening may be referred to as “tri-titanium particle formation. If the base material is aluminum (Al), such transformation strengthening may be referred to as “trialuminide particle formation,” etc. There also may be other forms of particles formed, such as a base material with two interstitial solutes or between interstitial and substitutional solutes, which may have a “di-” prefix, e.g., titanium diboride where both titanium and boron are used as solutes, etc., without departing from the scope of the present disclosure. Any number of different compounds, described with chemical prefixes, suffixes, and numerical monikers, comprising, consisting essentially of, and/or consisting base material(s) and/or solute(s) may be created within an alloy without departing from the scope of the present disclosure.

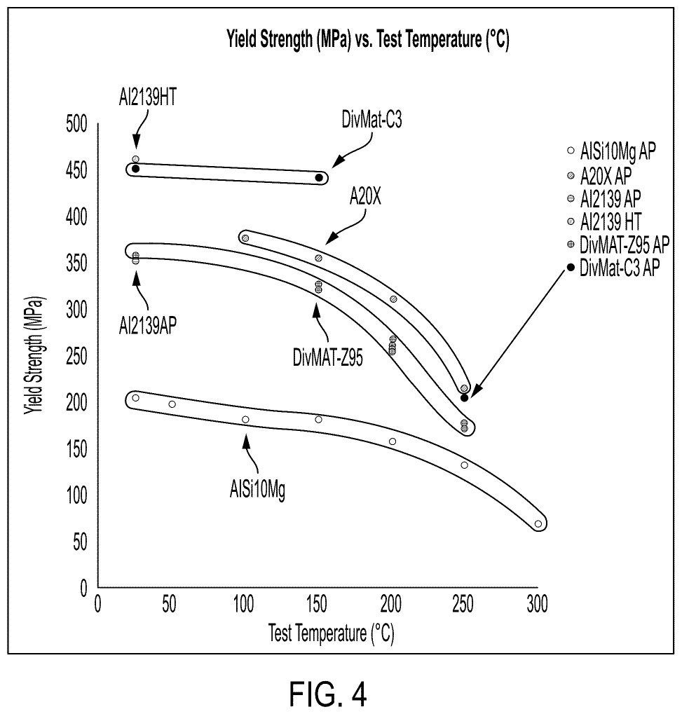

FIG. 4 illustrates yield strength versus temperature of different alloys.

As illustrated in FIGS. 4-6, “AP” and “HT” after the name of the alloys stand for “as-printed” and “heat treated”, respectively. Applicants Al—Cu—Mg—Zr disclosed alloys (e.g., DivMat-C3 and DivMAT-Z95) may obtain high yield strengths over a wide temperature range, which for example, may range from above 0° C. to 250° C. Also, for example, at a temperature of 150° C. applicants Al—Cu—Mg—Zr disclosed alloy(s) (e.g., Divmat-C3) has/have a yield strength substantially higher than the yield strength of at least the conventional alloys of AlSilOMg and A20X. Additionally, at a temperature below 50° C. applicants Al—Cu—Mg—Zr disclosed alloys (e.g., Divmat-C3 and DivMAT-Z95) have a yield strength higher than the yield strength of at least the conventional alloys of AlSi10Mg and A2139 AP.

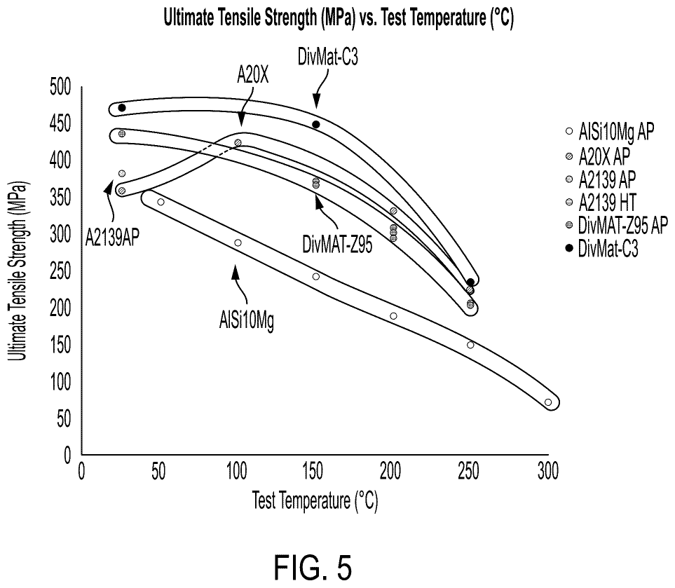

FIG. 5 illustrates ultimate tensile strength versus temperature of different alloys.

As illustrated in FIG. 5, Applicants Al—Cu—Mg—Zr disclosed alloys (e.g., DivMat-C3 and DivMAT-Z95) may obtain high ultimate tensile strengths over a wide temperature range, which for example, may range from above 0° C. to 250° C. Also, for example, at a temperature below 50° C. applicants Al—Cu—Mg—Zr disclosed alloys (e.g., Divmat-C3 and DivMAT-Z95) have an ultimate tensile strength substantially higher than the ultimate tensile strength of at least the conventional alloys of A20X and A2139 AP. Additionally, at a temperature of 250° C. applicants Al—Cu—Mg—Zr disclosed alloy(s) (e.g., Divmat-C3) has/have an ultimate tensile strength higher than the ultimate tensile strength of at least the conventional alloys of AlSi10Mg and A20X.

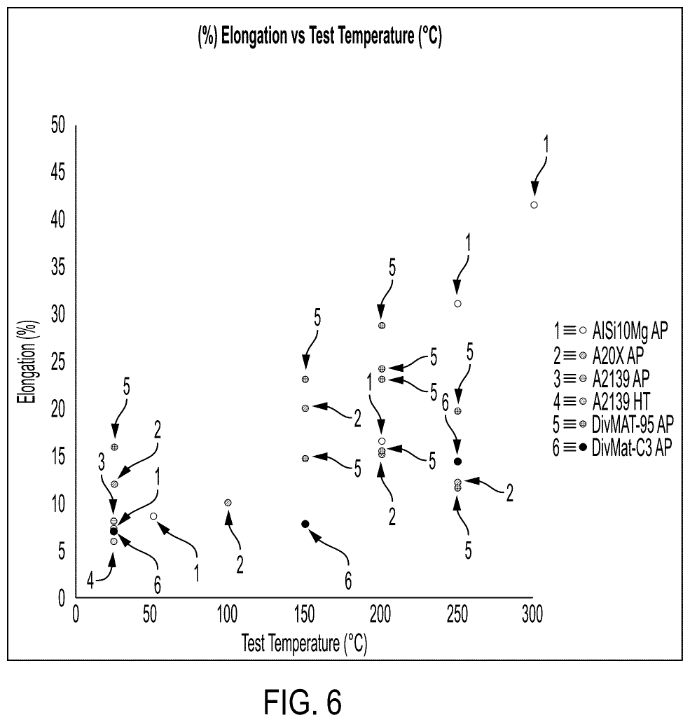

FIG. 6 illustrates percent elongation versus temperature of different alloys.

As illustrated in FIG. 6, Applicants Al—Cu—Mg—Zr disclosed alloys (e.g., DivMat-C3 and DivMAT-Z95) may obtain large elongation percentages over a wide temperature range, which for example, may range from above 0° C. to 250° C. For example, as the temperature increases, for example, at a temperature from above 0° C., at 150° C. and at 250° C. applicants Al—Cu—Mg—Zr disclosed alloy(s) (e.g., Divmat-C3) increase in percentage elongation. Also, for example, as the temperature increases, for example, at a temperature from above 0° C. to 200° C. applicants Al—Cu—Mg—Zr disclosed alloy(s) (e.g., Divmat-C3 and DivMAT-Z95) may increase in percentage elongation.

### Alloy Compositions

In an aspect of the present disclosure, aluminum (Al) may be alloyed with a set of other materials, such as one or more elements. Example elements that may be used to form Al alloys in some embodiment may include iron (Fe), manganese (Mn), silicon (Si), nickel (Ni), zirconium (Zr), copper (Cu), magnesium (Mg), lithium (Li), titanium (Ti), and/or some combination of all or a subset of the foregoing set of elements.

The disclosed alloys of the present disclosure may be configured with a balance of Al. In some aspects, the balance may include at most 0.1% by weight of trace elements. In some aspects, the balance of the Al of an alloy may include up to 0.1% by weight of trace impurities cumulatively and 0.01% individually.

Titanium and zirconium may be used as a grain refiner of aluminum alloys.

While Al alloyed with Mg and/or Mn may provide relatively high strength and/or high ductility, the relatively high strength may be derived through solid solution strengthening. Mn may eliminate weak eliminate weak θ-Al₁₃Fe₄. Thus, one or more alloys of the present disclosure may be configured for solid solution strengthening and, additionally, for precipitation hardening. In so doing, the one or more alloys of the present disclosure may be suitable for AM applications, including 3-D printing. For example, one or more alloys of the present disclosure may be configured with one or more other elements, in addition to Mg and/or Mn with a balance of Al. With the addition of the one or more other elements, the one or more alloys described herein may be suitable for AM applications, such as 3-D printing, while still providing relatively high strength, ductility, and/or durability.

In alloying, various properties may be derived through different elements, e.g., when included in a solid solution with Al. Also, the fast cooling rate associated with AM may increase the solubility limits of various elements included in one or more alloys described herein, thereby resulting in microstructures that are relatively finer in comparison with those of conventional or non-AM processing techniques.

In various embodiments, an alloy may include aluminum (Al), iron (Fe) and manganese (Mn), which may be referred to as an Al—Fe—Mn alloy. The Al—Fe—Mn alloy adopts two solid solution strengthening elements. The eutectic Al₆M microstructures at the melt pool boundary further increase strength. The alloy provides good laser processability and a tensile strength up to 378 MPa in an as-printed state. The optional elements Si, and/or Ni, and/or Zr, also contribute to strength. For example, the below TABLE 1 provides for strengthening mechanism(s) for elements of various example alloys of this disclosure.

TABLE 1

| | | |
|---|---|---|
| Element | Range (wt. %) | Strengthening mechanism |

Base alloy

| | | |
|---|---|---|
| Al | Bal. (Balance) | — |
| Fe | 1.0-5.8; 1.75-4.75; 2.0-3.75 | Al₆Fe |
| Mn | 1.2-9.1; 1.75-5.0; 2.0-4.0 | Al₆Mn, eliminate weak |
| | | θ-Al₁₃Fe₄ |

Optionally added elements

| | | |
|---|---|---|
| Si | 0-3.9; 0.25-3.0; 0.25-2.25 | α-Al(FeMn)Si |
| Ni | 0-7.6 (0-2.9); 0.5-5.0; 0.5-3.5 | Al₃Ni, Al₉FeNi |
| Zr | 0-3.8; 0.25-3.25; 0.25-3.0 | Grain refinement, Al₃Zr |

In various embodiments, one or more alloys may include Al, Fe and Mn (i.e., Al—Fe—Mn alloy). In various embodiments of the Al—Fe—Mn alloy, Fe may include 1% by weight of the alloy and up to and including 5.8% (i.e., Fe∈[1%, 5.8%]) by weight of the alloy, Mn may include 1.2% by weight of the alloy and up to and including 9.1% (i.e., Mn∈[1.2%, 9.1%]) by weight of the alloy, and Al may include a balance of the weight percentage of the alloy. In some further embodiments, the Al—Fe—Mn alloy may further include one or more of the elements silicon (Si), nickel (Ni), and zirconium (Zr). In some embodiments, Si may include up to and including 3.9% (i.e., Si≤3.9%) by weight of the alloy. In some embodiments, Ni may include up to and including 7.6% (i.e., Ni≤7.6%) by weight of the alloy. In some embodiments, Zr may include up to and including 3.8% (i.e., Zr≤3.8%) by weight of the alloy. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments of an Al—Fe—Mn alloy, Fe may include 1.75% by weight of the alloy and up to and including 4.75% by weight of the alloy, Mn may include 1.75% by weight of the alloy and up to and including 5.0% by weight of the alloy, and Al may be a balance of the weight percentage of the alloy. In some further embodiments, the Al—Fe—Mn alloy may further include one or more of the elements silicon (Si), nickel (Ni), and zirconium (Zr). In some embodiments, Si may include 0.25% by weight of the alloy and up to and including 3.0% by weight of the alloy. In some embodiments, Ni may include 0.5% by weight of the alloy and up to and including 5.0% by weight of the alloy. In some embodiments, Zr may include 0.25% by weight of the alloy and up to and including 3.25% by weight of the alloy. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments of an Al—Fe—Mn alloy, Fe may include 2.0% by weight of the alloy and up to and including 3.75% by weight of the alloy, Mn may include 2.0% by weight of the alloy and up to and including 4.0% by weight of the alloy, and Al may be a balance of the weight percentage of the alloy. In some further embodiments, the Al—Fe—Mn alloy may further include one or more of the elements silicon (Si), nickel (Ni), and zirconium (Zr). In some embodiments, Si may include 0.25% by weight of the alloy and up to and including 2.25% by weight of the alloy. In some embodiments, Ni may include 0.5% by weight of the alloy and up to and including 3.5% by weight of the alloy. In some embodiments, Zr may include 0.25% by weight of the alloy and up to and including 3.0% by weight of the alloy. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments, one or more alloys may include aluminum (Al), copper (Cu), magnesium (Mg) and zirconium (Zr), which may be referred to as an Al—Cu—Mg—Zr alloy. The addition of zirconium (Zr) within an alloy of aluminum (Al), copper (Cu) and magnesium (Mg) (i.e., Al—Cu—Mg—Zr) may help eliminate formation of cracks during an additive manufacturing process by providing nucleation sites for finer grain microstructures. At room temperature, the as-printed alloys may exhibit 450 MPa yield strength and 500 MPa yield strength. Also, at room temperature, the as-printed alloys may exhibit 486 MPa tensile strength/ultimate tensile strength and 500 MPa tensile strength/ultimate tensile strength. At temperatures up to 250 degrees Celsius (i.e., 250° C.), the alloys (e.g., DivMat-C3 AP, which corresponds to the compositions including Al—Cu—Mg—Zr—Mn) show superior strength over competitors. A ratio of copper to magnesium (i.e., Cu/Mg) may have values within the range from 3 to 1 (i.e., a ratio of Cu/Mg∈[1,3]) to generate a desired precipitate. Additionally, the below TABLE 2 provides for strengthening mechanism(s) for elements of various example alloys of this disclosure.

TABLE 2

| | | |
|---|---|---|
| | | Strengthening |
| Element | Range (wt. %) | mechanism |

Base alloy

| | | |
|---|---|---|
| Al | Bal. (Balance) | — |
| Cu | 0.8-5.1; 2.8-5.1; 2.0-5.1; 2.0-4.0; | Al₂Cu, Al₂CuMg, |
| | 2.25-3.25; 2.5-4.5; 3.0-4.0 | solid solution |
| Mg | 0.5-3.9; 2.6-3.9; 0.5-3.9; 0.5-2.0; | Al₂CuMg, solid |
| | 0.75-1.75; 2.5-3.9; 3.0-3.9 | solution |
| Zr | 0.3-10; 1.1-4.1; 1.1-4.1; 1.75-4.1; | Grain refinement, |
| | 1.75-3.75; 1.1-3.0; 1.1-2.0 | Al₃Zr |

Optionally added elements

| | | |
|---|---|---|
| Mn | 0-7.7; 0-7.7; 0-7.7; 1.0-4.0; 1.25-3.0; | Al₆Mn |
| | 0.2-2.0; 0.25-1.25 | |
| Li | 0-2.1; 0-2.1; 0-2.1; 1.0-2.0; 1.25-2.0; | Al₂CuLi |
| | 0.75-2.0; 1.0-1.75 | |
| Ti | 0-6.4; 0-6.4; 0-6.4; 0.5-4.4; 0.5-3.5; | Grain refinement, |
| | 0.55-3.75; 0.55-3.0 | Al₃Ti |
| Si | 0-3.8; 0-3.8; 0-3.8; 0.25-3.0; 0.25-2.0; | Mg₂Si |
| | 0.25-2.5; 0.25-2.0 | |
| Fe | 0-1.5; 0-1.5; 0-1.5; 0.25-1.25; 0.25-1.0; | (Al, Cu)₉FeNi |
| | 0.45-1.5; 0.45-1.0 | |
| Ni | 0-1.4; 0-1.4; 0-1.4; 0.5-1.25; 0. 5-1.0; | (Al, Cu)₉FeNi |
| | 0.25-1.5; 0.25-1.25 | |

In various embodiments, one or more alloys may include Al, Cu, Mg and Zr (i.e., Al—Cu—Mg—Zr alloy). In various embodiments of the Al—Cu—Mg—Zr alloy, Cu may include 0.8% by weight of the alloy and up to and including 5.1% (i.e., Cu∈[0.8%, 5.1%]) by weight of the alloy, Mg may include 0.5% by weight of the alloy and up to and including 3.9% (i.e., Mg∈[0.5%, 3.9%]) by weight of the alloy, Zr may include 0.3% by weight of the alloy and up to and including 10.0% (i.e., Zr∈[0.3%, 10%]) by weight of the alloy, and Al may include a balance of the weight percentage of the alloy. In some further embodiments, the Al—Cu—Mg—Zr alloy may include one or more of the elements manganese (Mn), lithium (Li), titanium (Ti), silicon (Si), iron (Fe) and nickel (Ni). In some embodiments, Mn may include up to and including 7.7% (i.e., Mn≤7.7%) by weight of the alloy. In some embodiments, Li may include up to and including 2.1% (i.e., Li≤2.1%) by weight of the alloy. In some embodiments, Ti may include up to and including 6.4% (i.e., Ti≤6.4%) by weight of the alloy. In some embodiments, Si may include up to and including 3.8% (i.e., Si≤3.8%) by weight of the alloy. In some embodiments, Fe may include up to and including 1.5% (i.e., Fe≤1.5%) by weight of the alloy. In some embodiments, Ni may include up to and including 1.5% (i.e., Ni≤1.5%) by weight of the alloy. In some embodiments, the alloy may include a ratio of Cu to Mg (i.e., Cu/Mg) in the range from 1 to 3 (i.e., a ratio of Cu/Mg∈[1,3]), which includes the endpoint values of the range. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments of an Al—Cu—Mg—Zr alloy, Cu may include 2.8% by weight of the alloy and up to and including 5.1% by weight of the alloy, Mg may include 2.6% by weight of the alloy and up to and including 3.9% by weight of the alloy, Zr may include 1.1% by weight of the alloy and up to and including 4.1% by weight of the alloy, and Al may include a balance of the weight percentage of the alloy. In some further embodiments, the Al—Cu—Mg—Zr alloy may include one or more of the elements manganese (Mn), lithium (Li), titanium (Ti), silicon (Si), iron (Fe) and nickel (Ni). In some embodiments, Mn may include up to and including 7.7% by weight of the alloy. In some embodiments, Li may include up to and including 2.1% by weight of the alloy. In some embodiments, Ti may include up to and including 6.4% by weight of the alloy. In some embodiments, Si may include up to and including 3.8% by weight of the alloy. In some embodiments, Fe may include up to and including 1.5% by weight of the alloy. In some embodiments, Ni may include up to and including 1.5% by weight of the alloy. In some embodiments, the alloy may include a ratio of Cu to Mg (i.e., Cu/Mg) in the range from 1 to 3 (i.e., a ratio of Cu/Mg∈[1,3]), which includes the endpoint values of the range. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments of an Al—Cu—Mg—Zr alloy, Cu may include 2.0% by weight of the alloy and up to and including 5.1% by weight of the alloy, Mg may include 0.5% by weight of the alloy and up to and including 3.9% by weight of the alloy, Zr may include 1.1% by weight of the alloy and up to and including 4.1% by weight of the alloy, and Al may include a balance of the weight percentage of the alloy. In some further embodiments, the Al—Cu—Mg—Zr alloy may include one or more of the elements manganese (Mn), lithium (Li), titanium (Ti), silicon (Si), iron (Fe) and nickel (Ni). In some embodiments, Mn may include up to and including 7.7% by weight of the alloy. In some embodiments, Li may include up to and including 2.1% by weight of the alloy. In some embodiments, Ti may include up to and including 6.4% by weight of the alloy. In some embodiments, Si may include up to and including 3.8% by weight of the alloy. In some embodiments, Fe may include up to and including 1.5% by weight of the alloy. In some embodiments, Ni may include up to and including 1.5% by weight of the alloy. In some embodiments, the alloy may include a ratio of Cu to Mg (i.e., Cu/Mg) in the range from 1 to 3 (i.e., a ratio of Cu/Mg∈[1,3]), which includes the endpoint values of the range. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments of an Al—Cu—Mg—Zr alloy, Cu may include 2.0% by weight of the alloy and up to and including 4.0% by weight of the alloy, Mg may include 0.5% by weight of the alloy and up to and including 2.0% by weight of the alloy, Zr may include 1.75% by weight of the alloy and up to and including 4.1% by weight of the alloy, and Al may include a balance of the weight percentage of the alloy. In some further embodiments, the Al—Cu—Mg—Zr alloy may include one or more of the elements manganese (Mn), lithium (Li), titanium (Ti), silicon (Si), iron (Fe) and nickel (Ni). In some embodiments, Mn may include 1.0% by weight of the alloy and up to and including 4.0% by weight of the alloy. In some embodiments, Li may include 1.0% by weight of the alloy and up to and including 2.0% by weight of the alloy. In some embodiments, Ti may include 0.5% by weight of the alloy and up to and including 4.4% by weight of the alloy. In some embodiments, Si may include 0.25% by weight of the alloy and up to and including 3.0% by weight of the alloy. In some embodiments, Fe may include 0.25% by weight of the alloy and up to and including 1.25% by weight of the alloy. In some embodiments, Ni may include 0.5% by weight of the alloy and up to and including 1.25% by weight of the alloy. In some embodiments, the alloy may include a ratio of Cu to Mg (i.e., Cu/Mg) in the range from 1 to 3 (i.e., a ratio of Cu/Mg∈[1,3]), which includes the endpoint values of the range. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments of an Al—Cu—Mg—Zr alloy, Cu may include 2.25% by weight of the alloy and up to and including 3.25% by weight of the alloy, Mg may include 0.75% by weight of the alloy and up to and including 1.75% by weight of the alloy, Zr may include 1.75% by weight of the alloy and up to and including 3.75% by weight of the alloy, and Al may include a balance of the weight percentage of the alloy. In some further embodiments, the Al—Cu—Mg—Zr alloy may include one or more of the elements manganese (Mn), lithium (Li), titanium (Ti), silicon (Si), iron (Fe) and nickel (Ni). In some embodiments, Mn may include 1.25% by weight of the alloy and up to and including 3.0% by weight of the alloy. In some embodiments, Li may include 1.25% by weight of the alloy and up to and including 2.0% by weight of the alloy. In some embodiments, Ti may include 0.5% by weight of the alloy and up to and including 3.5% by weight of the alloy. In some embodiments, Si may include 0.25% by weight of the alloy and up to and including 2.0% by weight of the alloy. In some embodiments, Fe may include 0.25% by weight of the alloy and up to and including 1.0% by weight of the alloy. In some embodiments, Ni may include 0.5% by weight of the alloy and up to and including 1.0% by weight of the alloy. In some embodiments, the alloy may include a ratio of Cu to Mg (i.e., Cu/Mg) in the range from 1 to 3 (i.e., a ratio of Cu/Mg∈[1,3]), which includes the endpoint values of the range. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments of an Al—Cu—Mg—Zr alloy, Cu may include 2.5% by weight of the alloy and up to and including 4.5% by weight of the alloy, Mg may include 2.5% by weight of the alloy and up to and including 3.9% by weight of the alloy, Zr may include 1.1% by weight of the alloy and up to and including 3.0% by weight of the alloy, and Al may include a balance of the weight percentage of the alloy. In some further embodiments, the Al—Cu—Mg—Zr alloy may include one or more of the elements manganese (Mn), lithium (Li), titanium (Ti), silicon (Si), iron (Fe) and nickel (Ni). In some embodiments, Mn may include 0.2% by weight of the alloy and up to and including 2.0% by weight of the alloy. In some embodiments, Li may include 0.75% by weight of the alloy and up to and including 2.0% by weight of the alloy. In some embodiments, Ti may include 0.55% by weight of the alloy and up to and including 3.75% by weight of the alloy. In some embodiments, Si may include 0.25% by weight of the alloy and up to and including 2.5% by weight of the alloy. In some embodiments, Fe may include 0.45% by weight of the alloy and up to and including 1.5% by weight of the alloy. In some embodiments, Ni may include 0.25% by weight of the alloy and up to and including 1.5% by weight of the alloy. In some embodiments, the alloy may include a ratio of Cu to Mg (i.e., Cu/Mg) in the range from 1 to 3 (i.e., a ratio of Cu/Mg∈[1,3]), which includes the endpoint values of the range. According to various embodiments, the Al may be a balance of the composition. In some embodiments, the balance may include at most 0.1% by weight of trace elements. In some embodiments, the balance of the Al of an alloy may include up to 0.1% by weight of trace impurities cumulatively and 0.01% individually.

In various embodiments of an Al—Cu—Mg—Zr alloy, Cu may include 3.0% by weight of the alloy and up to and including 4.0% by weight of the alloy, Mg may include 3.0% by weight of the alloy and up to and including 3.9% by weight of the alloy, Zr may include 1.1% by weight of the alloy and up to and including 2.0% by weight of the alloy, and Al may include a balance of the weight percentage of the alloy. In some further embodiments, the Al—Cu—Mg—Zr alloy may include one or more of the elements manganese (Mn), lithium (Li), titanium (Ti), silicon (Si), iron (Fe) and nickel (Ni). In some embodiments, Mn may include 0.25% by weight of the alloy and up to and including 1.25% by weight of the alloy. In some embodiments, Li may include 1.0% by weight of the alloy and up to and including 1.75% by weight of the alloy. In some embodiments, Ti may include 0.55% by weight of the alloy and up to and including 3.0% by weight of the alloy. In some embodiments, Si may include 0.25% by weight of the alloy and up to and including 2.0% by weight of the alloy. In some embodiments, Fe may include 0.45% by weight of the alloy and up to and including 1.0% by weight of the alloy. In some embodiments, Ni may include 0.25% by weight of the alloy and up to and including 1.25% by weight of the alloy. In some embodiments, the alloy may include a ratio of Cu to Mg (i.e., Cu/Mg) in the range from 1 to 3 (i.e., a ratio of Cu/Mg∈[1,3]), which includes the endpoint values of the range. According to various embodiments, the Al may be a balance of the composition. In some embodiments, the balance may include at most 0.1% by weight of trace elements. In some embodiments, the balance of the Al of an alloy may include

The disclosed range of values associated with any of the elements of an alloy are example range of values and are not intended to represent the only ranges. Different ranges of values of the above disclosed range of values may be included for any of the elements of an alloy. For example, Cu may include/have ranges (by weight of the alloy) such as [1.5, 5.1], [1.75, 4.75], [1.8, 4.8], [1.8, 5.1], [2, 4], [2, 4.68], [2, 5.1], [2.3, 4.9], [2.8, 5.1], [3, 5], [3, 5.1], etc. Also, any value of any range may be a lower range value, an upper range value or both a lower range value and an upper range value. For example, if [1,10] is a range of an element of an alloy, then 1.1 or 1.5 or 6, etc. may be a lower range value and 8 or 9 or 9.9, etc. may be an upper range value and the ranges [1.1, 8], [1.1, 9], [1.1, 9.9], [1.5, 8], [1.5, 9], [1.5, 9.9], [6, 8], [6, 9], [6, 9.9], etc. may be ranges for the element of the alloy. Also, any of the values of the range [1,10] may be both a lower range value and an upper range value. For example, the value 2 is a value of the range [1,10] and the ranges [2,5] and [1,2] may be ranges of an element of an alloy and therefore, 2 may be both a lower range value and an upper range value.

In the above tables (e.g., TABLE 1 and TABLE 2), each row is interchangeable with the corresponding row in the other tables.

The particular embodiments illustrated in FIGS. 1A-1E are some suitable examples of a PBF system employing principles of the present disclosure. Specifically, one or more of the aluminum alloys described herein may be used in the PBF system described in FIGS. 1A-1E. While one or more aluminum alloys described in the present disclosure may be suitable for various AM processes (e.g., using a PBF system, as shown in FIGS. 1A-1E), it will be appreciated that one or more aluminum alloys of the present disclosure may be suitable for other applications, as well. For example, one or more aluminum alloys described herein may be used in other fields or areas of manufacture without departing from the scope of the present disclosure. Accordingly, AM processes employing the one or more aluminum alloys of the present disclosure are to be regarded as illustrative, and are not intended to limit the scope of the present disclosure.

In some exemplary applications, the one or more alloys of the present disclosure may be used for AM in automotive engineering. For example, the one or more alloys described herein may be additively manufactured for the production of nodes, joints, and/or other structures, which may be applied in vehicles (e.g., cars, trucks, etc.). For example, the one or more alloys described herein may be additively manufactured to produce all or a portion of a chassis, frame, body, etc. of a vehicle.

The characteristics of the one or more alloys described herein may contribute to the crashworthiness of structures produced from the one or more alloys described herein. Moreover, the one or more alloys of the present disclosure may be configured with the materials (e.g., elements) described herein so that products additively manufactured using at least a portion of the one or more alloys may reduce the weight of vehicles at a suitable insertion point (e.g., in comparison with existing approaches to vehicle manufacture).

The previous description is provided to enable any person skilled in the art to practice the various aspects described herein. Various modifications to these exemplary embodiments presented throughout this disclosure will be readily apparent to those skilled in the art, and the concepts disclosed herein may be applied to aluminum alloys. Thus, the claims are not intended to be limited to the exemplary embodiments presented throughout the disclosure but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An alloy comprising:
iron (Fe), wherein an amount of the Fe is greater than 1% by weight of the alloy and less than or equal to 5.8% by weight of the alloy;
manganese (Mn), wherein an amount of the Mn is greater than or equal to 1.2% by weight of the alloy and less than or equal to 9.1% by weight of the alloy; and
aluminum (Al).

2. The alloy of claim 1, wherein the amount of the Fe is greater than or equal to 1.5% by weight of the alloy.

3. The alloy of claim 1, wherein the amount of the Fe is between 1.75% and 5.5% by weight of the alloy.

4. The alloy of claim 1, wherein the amount of the Mn is greater than or equal to 1.75% by weight of the alloy.

5. The alloy of claim 1, wherein the amount of the Mn is between 2% and 5% by weight of the alloy.

6. The alloy of claim 1, further comprising silicon (Si) in an amount less than or equal to 3.9% by weight of the alloy.

7. The alloy of claim 1, further comprising silicon (Si) in an amount between 0.25% and 3% by weight of the alloy.

8. The alloy of claim 1, further comprising nickel (Ni) in an amount less than or equal to 7.6% by weight of the alloy.

9. The alloy of claim 1, further comprising nickel (Ni) in an amount between 0.5% and 3% by weight of the alloy.

10. The alloy of claim 1, further comprising zirconium (Zr) in an amount less than or equal to 3.8% by weight of the alloy.

11. The alloy of claim 1, further comprising zirconium (Zr) in an amount between 0.25% and 3.25% by weight of the alloy.

12. The alloy of claim 1, wherein the amount of the Fe is between 1.8% and 4% by weight of the alloy and the amount of the Mn is between 2.2% and 4.5% by weight of the alloy.

13. An alloy comprising:
copper (Cu), wherein an amount of the Cu is greater than 0.8% by weight of the alloy and less than or equal to 5.1% by weight of the alloy;
magnesium (Mg);
zirconium (Zr), wherein an amount of the Zr is greater than 0.3% by weight of the alloy and less than or equal to 10.0% by weight of the alloy; and
aluminum (Al).

14. The alloy of claim 13, wherein the amount of the Cu is greater than or equal to 1.5% by weight of the alloy.

15. The alloy of claim 13, wherein the amount of the Cu is between 1.8% and 4.8% by weight of the alloy.

16. The alloy of claim 13, wherein an amount of the Mg is less than or equal to 3.9% by weight of the alloy.

17. The alloy of claim 16, wherein the amount of the Mg is greater than or equal to 0.5% by weight of the alloy.

18. The alloy of claim 13, wherein an amount of the Mg is between 1.5% and 3.8% by weight of the alloy.

19. The alloy of claim 13, wherein the amount of the Zr is greater than or equal to 0.8% by weight of the alloy.

20. The alloy of claim 19, wherein the amount of the Zr is less than or equal to 6% by weight of the alloy.

21. The alloy of claim 13, wherein the amount of the Zr is between 1% and 5% by weight of the alloy.

22. The alloy of claim 13, further comprising manganese (Mn) in an amount less than or equal to 7.7% by weight of the alloy.

23. The alloy of claim 13, further comprising lithium (Li) in an amount less than or equal to 2.1% by weight of the alloy.

24. The alloy of claim 13, further comprising titanium (Ti) in an amount less than or equal to 6.4% by weight of the alloy.

25. The alloy of claim 13, further comprising silicon (Si) in an amount less than or equal to 3.8% by weight of the alloy.

26. The alloy of claim 13, further comprising iron (Fe) in an amount less than or equal to 1.5% by weight of the alloy.

27. The alloy of claim 13, further comprising nickel (Ni) in an amount less than or equal to 1.4% by weight of the alloy.

28. The alloy of claim 13, further comprising manganese (Mn), wherein an amount of the Mn is between 2% and 4% by weight of the alloy;
wherein the amount of the Cu is between 2% and 4% by weight of the alloy;
wherein an amount of the Mg is between 2% and 3.7% by weight of the alloy; and
wherein the amount of the Zr is between 2% and 4% by weight of the alloy.

29. An alloy comprising:
copper (Cu), wherein an amount of the Cu is greater than or equal to 2.0% by weight of the alloy and less than or equal to 5.1% by weight of the alloy;
magnesium (Mg);
zirconium (Zr), wherein an amount of the Zr is greater than or equal to 1.1% by weight of the alloy and less than or equal to 4.1% by weight of the alloy; and
aluminum (Al).

30. The alloy of claim 29, wherein an amount of the Mg is between 0.5% and 3.9% by weight of the alloy.

31. The alloy of claim 29, further comprising manganese (Mn) in an amount less than or equal to 7.7% by weight of the alloy.

32. The alloy of claim 29, further comprising lithium (Li) in an amount less than or equal to 2.1% by weight of the alloy.

33. The alloy of claim 29, further comprising titanium (Ti) in an amount less than or equal to 6.4% by weight of the alloy.

34. The alloy of claim 29, further comprising silicon (Si) in an amount less than or equal to 3.8% by weight of the alloy.

35. The alloy of claim 29, further comprising iron (Fe) in an amount less than or equal to 1.5% by weight of the alloy.

36. The alloy of claim 29, further comprising nickel (Ni) in an amount less than or equal to 1.4% by weight of the alloy.

37. The alloy of claim 29, further comprising manganese (Mn), wherein an amount of the Mn is between 2% and 4% by weight of the alloy;
wherein the amount of the Cu is between 2% and 4% by weight of the alloy;
wherein an amount of the Mg is between 2% and 3.7% by weight of the alloy; and
wherein the amount of the Zr is between 2% and 4% by weight of the alloy.

38. An alloy comprising:
copper (Cu), wherein an amount of the Cu is greater than or equal to 2.8% by weight of the alloy and less than or equal to 5.1% by weight of the alloy;
magnesium (Mg);
zirconium (Zr), wherein an amount of the Zr is greater than or equal to 1.1% by weight of the alloy and less than or equal to 4.1% by weight of the alloy; and
aluminum (Al).

39. The alloy of claim 38, wherein an amount of the Mg is greater than or equal to 2.6% by weight of the alloy and less than or equal to 3.9% by weight of the alloy.

40. The alloy of claim 38, further comprising manganese (Mn) in an amount less than or equal to 7.7% by weight of the alloy.

41. The alloy of claim 38, further comprising lithium (Li) in an amount less than or equal to 2.1% by weight of the alloy.

42. The alloy of claim 38, further comprising titanium (Ti) in an amount less than or equal to 6.4% by weight of the alloy.

43. The alloy of claim 38, further comprising silicon (Si) in an amount less than or equal to 3.8% by weight of the alloy.

44. The alloy of claim 38, further comprising iron (Fe) in an amount less than or equal to 1.5% by weight of the alloy.

45. The alloy of claim 38, further comprising nickel (Ni) in an amount less than or equal to 1.4% by weight of the alloy.

46. The alloy of claim 38, further comprising manganese (Mn), wherein an amount of the Mn is between 2.2% and 3.8% by weight of the alloy;
wherein the amount of the Cu is between 2.8% and 4% by weight of the alloy; and
wherein an amount of the Mg is between 2.6% and 3.7% by weight of the alloy; and
wherein the amount of the Zr is between 2% and 4% by weight of the alloy.
